(19) United States
(12) Patent Application Publication
(10) Pub. No.: US 2018/0336110 A1
(43) Pub. Date: Nov. 22, 2018

(54) INFORMATION PROCESSING DEVICE AND METHOD FOR CONTROLLING INFORMATION PROCESSING DEVICE

(71) Applicant: FUJITSU LIMITED, Kawasaki-shi (JP)

(72) Inventors: Yutaro Iwakiri, Kawasaki (JP); HIROSHI KATAYAMA, Yokohama (JP); Daisuke Butsuda, Yokohama (JP); Tetsuo Tsujii, Yokohama (JP)

(73) Assignee: FUJITSU LIMITED, Kawasaki-shi (JP)

(21) Appl. No.: 15/983,139

(22) Filed: May 18, 2018

(30) Foreign Application Priority Data
May 22, 2017 (JP) 2017-101098

(51) Int. Cl. G06F 11/20

(52) U.S. Cl. CPC G06F 11/2023; G06F 2201/805

(57) ABSTRACT

An information processing device includes a memory and a processor coupled to the memory. the processor is configured to acquire first information indicating functions used by respective information processing systems. the processor is configured to acquire second information indicating functions that are usable by the information processing systems in respective sites. the processor is configured to determine, when a failure has occurred in a first information processing system of the information processing systems installed in a first site of the sites, a second site in which a first function used by the first information processing system is usable based on the acquired first information and the acquired second information. The second site is one of the sites and different from the first site. The second site serves as a first restoration destination in which the first information processing system is restored.

### CROSS-REFERENCE TO RELATED APPLICATION

This application is based upon and claims the benefit of priority of the prior Japanese Patent Application No. 2017-101098, filed on May 22, 2017, the entire contents of which are incorporated herein by reference.

### FIELD

The embodiment discussed herein is related to an information processing device and a method for controlling an information processing device.

### BACKGROUND

For a service to be provided using an information processing system including an information processing device such as a server, countermeasures such as disaster recovery (DR) are taken in some cases. In DR, a site that is similar to a certain site in which a service is actually operated is prepared as a backup site at a location geographically separated from the certain site for a disaster such as an earthquake. If a failure has occurred in the certain site used for the operation of the service upon the occurrence of a disaster, the site prepared as the backup site is used. By using this site, the service is quickly restored upon the occurrence of the disaster.

In addition, a technique for preparing multiple backup sites and using the multiple backup sites to restore, in a distributed manner, multiple information processing systems operating in a site in which a failure has occurred has been proposed. In addition, a technique for setting restoration priorities for information processing systems and restoring the information processing systems in order from an information processing system with the highest priority has been proposed.

Related techniques are disclosed in, for example, Japanese National Publication of International Patent Application No. 2010-530108, Japanese National Publication of International Patent Application No. 2015-510201, and Japanese Laid-open Patent Publication No. 2010-102468.

A function specific to a site, however, is used to provide a service in some cases. An example of the specific function is a function to be provided by a so-called public cloud. If public clouds are used, a region in which a certain public cloud is provided may be limited or a specification indicating that a dedicated line connected to a public cloud is used may be already determined. Thus, in the aforementioned techniques, an information processing system may be restored in a site located outside a region in which a public cloud is provided or may be restored in a site that does not satisfy the aforementioned specification or in which the dedicated line is not usable. As a result, in the site in which the information processing system is restored, the information processing system may not be able to use the service provided by the public cloud. Such problems are not limited to the service provided by the public cloud. Specifically, in the case where a function to be used in a site in which an information processing system is restored is different from a function to be provided in a backup site, the same problems may occur.

### SUMMARY

According to an aspect of the present invention, provided is an information processing device including a memory and a processor coupled to the memory. The processor is configured to acquire first information indicating functions used by respective information processing systems. The processor is configured to acquire second information indicating functions that are usable by the information processing systems in respective sites. the processor is configured to determine, when a failure has occurred in a first information processing system of the information processing systems installed in a first site of the sites, a second site in which a first function used by the first information processing system is usable based on the acquired first information and the acquired second information. The second site is one of the sites and different from the first site. The second site serves as a first restoration destination in which the first information processing system is restored.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of relationships between sites and services being used according to an embodiment;

FIG. 2 is a diagram illustrating an example of the configuration of each of managing servers according to the embodiment;

FIG. 3 is a flowchart of a process to be executed by a managing server according to the embodiment;

FIG. 4 is a flowchart of a subroutine process to be executed by the managing server according to the embodiment;

FIG. 5 is a diagram illustrating an example of a site management table according to the embodiment;

FIG. 6 is a diagram illustrating an example of an information processing system management table according to the embodiment;

FIG. 7 is a diagram illustrating an example of a site management table upon the occurrence of a failure of an information processing system according to the embodiment;

FIG. 8 is a diagram illustrating an example of a restoration process table according to the embodiment; and

FIG. 9 is a diagram illustrating the restoration process table after restoration destinations and details of a restoration process are determined according to the embodiment.

### DESCRIPTION OF EMBODIMENT

Hereinafter, an embodiment related to techniques disclosed herein is described with reference to the accompanying drawings. The following detailed description is an example and does not limit configurations described in the embodiment.

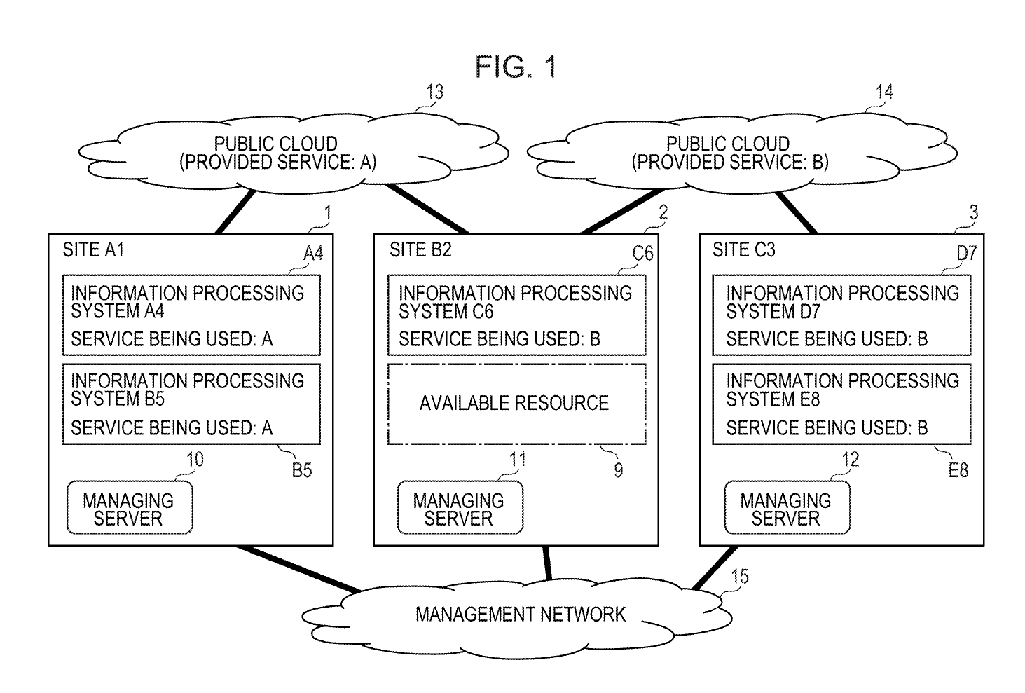

As illustrated in FIG. 1, in the embodiment, a site A1, a site B2, and a site C3 are built at locations geographically separated from each other. The site A1, the site B2, and the site C3 may be built at geographically the same location. The number of built sites is not limited to the number of the sites illustrated in FIG. 1. As an example, the sites function as data centers, and multiple information systems are installed in each of the sites. In each of the information processing systems installed in the sites, a virtual machine, storage, a network, and the like are combined.

The site A1 includes an information processing system A4, an information processing system B5, and a managing server 10. The site B2 includes an information processing system C6 and a managing server 11. The site C3 includes an information processing system D7, an information processing system E8, and a managing server 12. In the site B2, a single available resource 9 in which an information processing system is able to be installed remains. The managing server 10 is an example of an information processing device that determines a site that serves as a restoration destination of an information processing system and is among multiple sites in which information processing systems operate.

The site A1, the site B2, and the site C3 are connected to a management network 15. Thus, the managing servers 10 to 12 communicate with each other via the management network 15. The sites A1 and B2 are connected to a public cloud 13 providing a service A. The sites B2 and C3 are connected to a public cloud 14 providing a service B. Thus, the information processing systems A4 and B5 included in the site A1 may use the service A provided by the public cloud 13. The information processing system C6 included in the site B2 may use the service A provided by the public cloud 13 and the service B provided by the public cloud 14. The information processing systems D7 and E8 included in the site C3 may use the service B provided by the public cloud 14. The embodiment assumes that the service B provided by the public cloud 14 is not usable in the site A1 and that the service A provided by the public cloud 13 is not usable in the site C3.

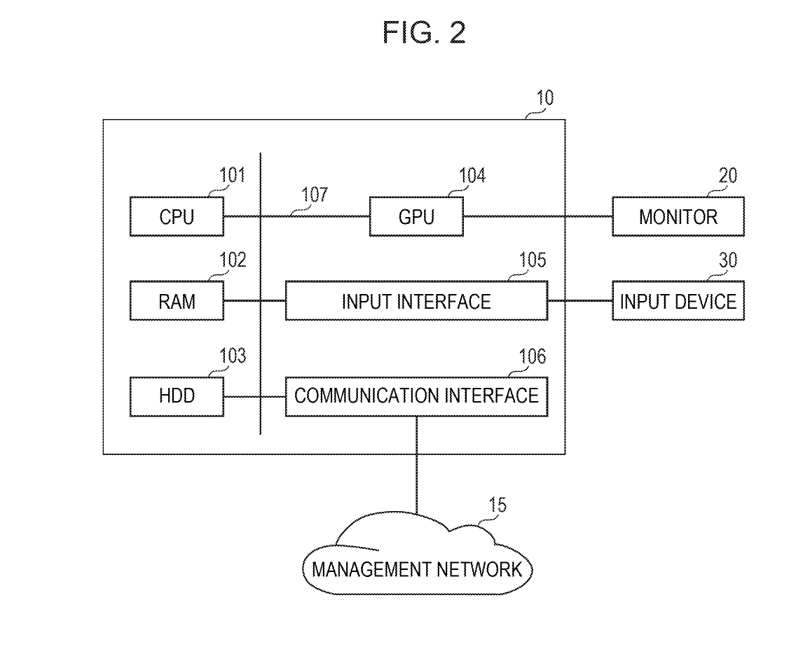

FIG. 2 illustrates an example of the configuration of the managing server 10 according to the embodiment. Each of the managing servers 11 and 12 has the same configuration as that of the managing server 10. The managing server 10 includes a central processing unit (CPU) 101, a random access memory (RAM) 102, a hard disk drive (HDD) 103, a graphics processing unit (GPU) 104, an input interface 105, and a communication interface 106. The GPU 104 is connected to a monitor 20, the input interface 105 is connected to an input device 30, and the communication interface 106 is connected to the management network 15. The CPU 101, the RAM 102, the HDD 103, the GPU 104, the input interface 105, and the communication interface 106 are connected to each other via a bus 107.

A user of the managing server 10 uses the input device 30 to provide various instructions to the managing server 10 and uses the monitor 20 to confirm processing results of the managing server 10. In the embodiment, the CPU 11 loads various programs stored in the HDD 103 into the RAM 102 and executes various processes described later.

In the embodiment, in the HDD 103 of the managing server 10, information on the types of the services usable in the sites and the numbers (capacities) of information processing systems able to be installed in the sites is stored in advance. The capacities are an example of resource amounts for the information processing systems able to be installed in the sites. In the HDD 103, information on the services to be used by the information processing systems and restoration priorities to be used to restore the information processing systems is stored in advance. In the following description, data obtained by organizing, as a table, information on the types of the services usable by the information processing systems in the sites and the capacities is referred to as a site management table. In the following description, data obtained by organizing, as a table, information on the services used by the information processing systems and the restoration priorities to be used to restore the information processing systems is referred to as an information processing system management table.

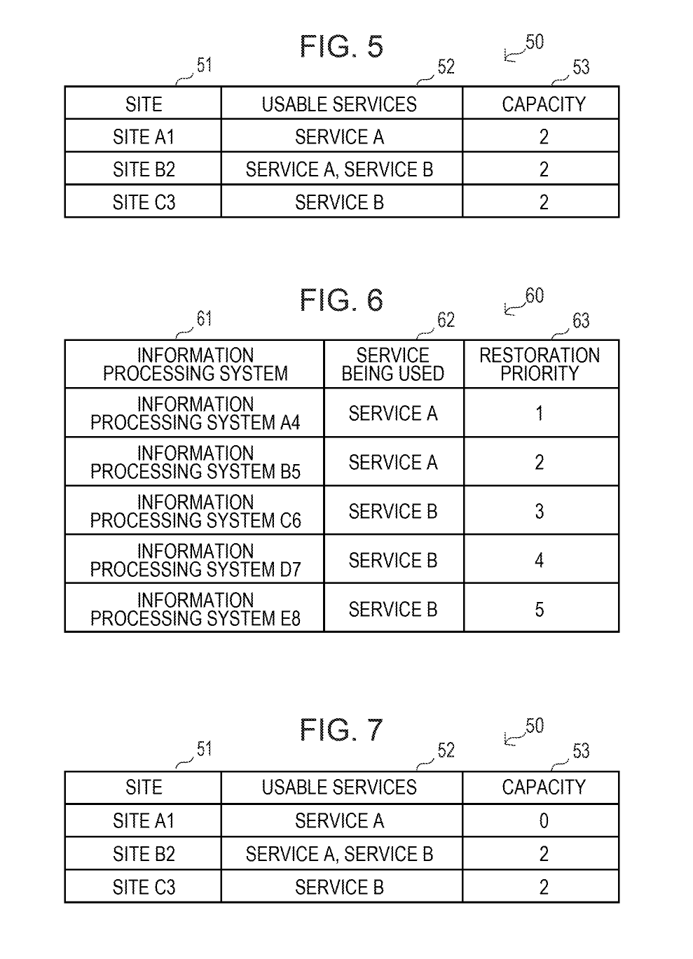

FIGS. 5 and 6 illustrate examples of the site management table and information processing system management table stored in the HDD 103. As illustrated in FIG. 5, as an example, in a site management table 50, the names of the sites are stored in a “site” item 51, the services usable in the sites are stored in a “usable services” item 52, and values indicating the capacities of the sites are stored in a “capacity” item 53. The services stored in the “usable services” item 52 are an example of second information on functions usable by the information processing systems in the sites. The values stored in the “capacity” item 53 and indicating the capacities are an example of third information on the totals of resource amounts for information processing systems able to be installed in the sites. The services usable in the sites and the numbers of information processing systems able to be installed in the sites are identified from the site management table 50.

As illustrated in FIG. 6, in an information processing system management table 60, the names of the information processing systems are stored in an “information processing system” item 61, and the services used by the information processing systems are stored in a “service being used” item 62, as an example. The services stored in the “service being used” item 62 are an example of first information on functions used by the information processing systems. In the information processing system management table 60, values indicating priorities to be used upon the restoration of the information processing systems are stored in a “restoration priority” item 63, as an example. The values stored in the “restoration priority” item 63 are natural numbers. As a value stored in the “restoration priority” item 63 is smaller, an information processing system associated with the value is preferentially restored. The values stored in the “restoration priority” item 63 are an example of fourth information on restoration priorities of the information processing systems. Restoration destinations of the information processing systems and the restoration priorities of the information processing systems are identified from the information processing system management table 60 upon the restoration of the information processing systems. A site in which a function indicated by the first information and used by an information processing system in which a failure has occurred is included in a usable function indicated by the second information is identified. The identified site is a restoration destination candidate.

In the embodiment, as an example, the managing servers 10 to 12 of the sites A1, B2, and C3 (illustrated in FIG. 1) communicate with each other via the management network 15, thereby synchronizing the information of the site management table 50 and the information of the information processing system management table 60. Thus, if a disaster occurs, a failure occurs in an information processing system, and the capacity of a site is reduced, the managing servers 10 to 12 may change the values stored in the “capacity” item 53. Thus, if the failure occurs in the information processing system, the managing servers 10 to 12 identify the capacities of the sites from the site management table 50. The embodiment assumes that the managing servers 10 to 12 share information such as resources used by the information processing systems installed in the sites. The sharing of the information of the information processing systems by the managing servers 10 to 12 may be achieved by a known technique, and a detailed description thereof is omitted.

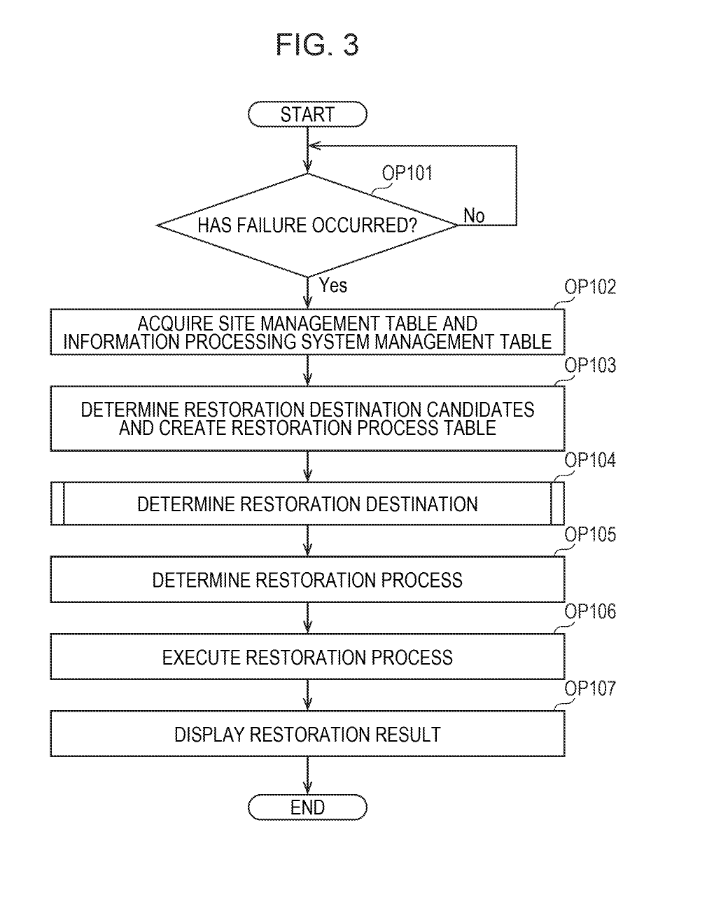

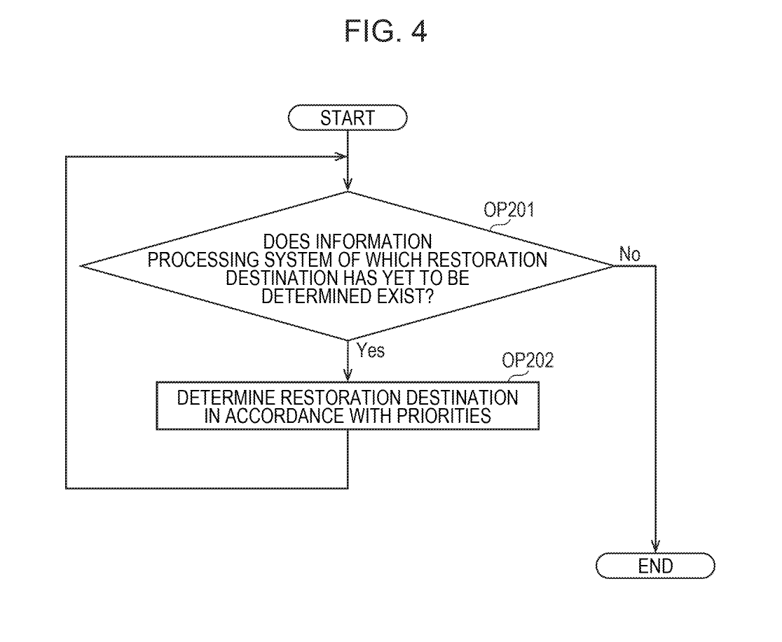

A process to be executed by the managing server 10 according to the embodiment is described with reference to flowcharts illustrated in FIGS. 3 and 4. The managing servers 10 to 12 may determine a representative server instead of the managing server 10, and the following process may be executed by the determined representative server. The determination of the representative server may be achieved using a known technique, and a detailed description thereof is omitted. FIGS. 3 and 4 illustrate an example of the flowcharts of the process to be executed by the CPU 101 of the managing server 10. When power is applied to the managing server 10, the CPU 101 of the managing server 10 starts the process of the flowchart illustrated in FIG. 3.

In OP101, the CPU 101 determines whether or not a failure has occurred in one or more of the information processing systems A4 to E8 installed in the sites A1, B2, and C3. Specifically, the managing servers 10 to 12 monitor failure occurrence states of the information processing systems installed in the sites (or the site A1 including the managing server 10, the site B2 including the managing server 11, and the site C3 including the managing server 12) of the managing servers 10 to 12. Then, if any of the managing servers 10 to 12 detects that a failure has occurred in one or more of information processing systems installed in a site including the managing server, the managing server notifies the occurrence of the failure to the other remaining managing servers. Thus, the managing servers 10 to 12 share information on the failure occurrence states of the information processing systems A4 to E8. Thus, in OP101, the CPU 101 may determine whether or not a failure has occurred in the information processing systems A4 to E8.

In the embodiment, if a failure has occurred in any of the information processing systems A4 to E8, information stored in the site management table 50 and related to the capacities is updated and the updated site management table 50 is shared by the managing servers 10 to 12. As an example, it is assumed that a disaster has occurred in the site A1 and a failure has occurred in each of the information processing systems A4 and B5. In this case, the managing server 10 updates the values indicated in the “capacity” item 53 of the site management table 50 stored in the HDD 133 from a state illustrated in FIG. 5 to a state illustrated in FIG. 7. Then, the managing server 10 transmits the updated site management table 50 to the managing servers 11 and 12 via the management network 15. By executing this, the site management table 50 illustrated in FIG. 7 is shared by the managing servers 10 to 12.

If the CPU 101 determines that the failure has occurred in one or more of the information processing systems A4 to E8 (Yes in OP101), the CPU 101 causes the process to proceed to OP102. On the other hand, if the CPU 101 determines that the failure has not occurred in the information processing systems A4 to E8 (No in OP101), the CPU 101 repeatedly executes the process of OP101.

In OP102, the CPU 101 functions as an acquirer and acquires the site management table 50 and the information processing system management table 60 from the HDD 103. Then, in OP103, the CPU 101 uses the acquired site management table 50 and the acquired information processing system management table 60 to determine restoration destination candidates of the information processing systems A4 to E8.

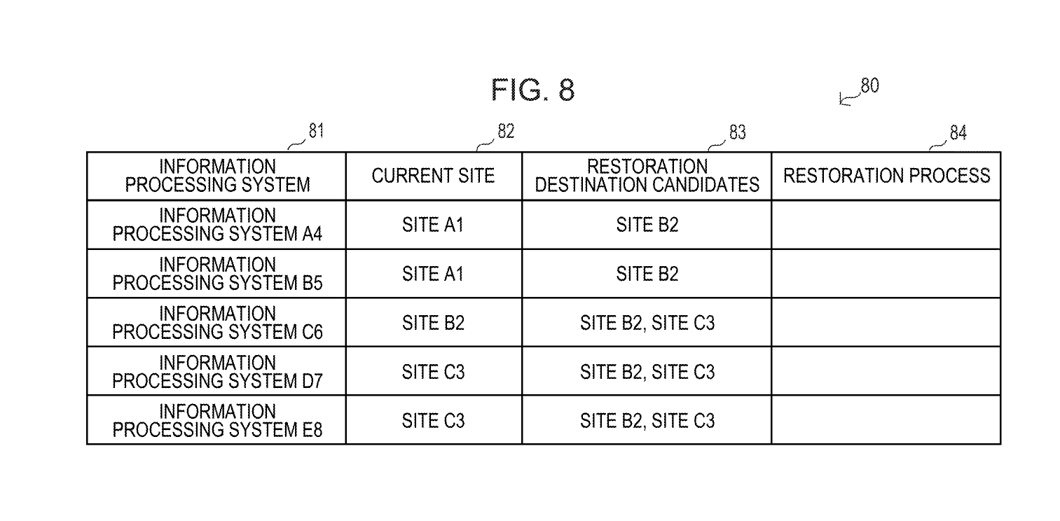

For example, if a disaster has occurred in the site A and a failure has occurred in each of the information processing systems A4 and B5, the CPU 101 acquires the site management table 50 illustrated in FIG. 7 and the information processing system management table 60 illustrated in FIG. 6 from the HDD 103 in OP102. Then, in OP103, the CPU 101 creates a restoration process table 80 exemplified in FIG. 8 from the acquired site management table 50 and the acquired information processing system management table 60. The restoration process table 80 defines restoration destination candidates of the information processing systems installed in the sites. As illustrated in FIG. 8, in the restoration process table 80, the names of the information processing systems installed in the sites are stored in an “information processing system” item 81, and the names of the sites in which the information processing systems are currently installed are stored in a “current site” item 82. In addition, in the restoration process table 80, the names of sites that are restoration destination candidates of the information processing systems are stored in a “restoration destination candidates” item 83, and details of the restoration process to be executed on the information processing systems are stored in a “restoration process” item 84.

Examples of the details of the restoration process are restoration, movement, maintenance, and stop. “Restoration” indicates that an information processing system in which a failure has occurred is restored. “Movement” indicates that an information processing system in which a failure does not occur is moved to another site. “Maintenance” indicates that an information processing system in which a failure does not occur is continuously installed in a site in which the information processing system is currently installed. “Stop” indicates that an information processing system is not installed since an available resource does not exist in a site. A stop process is executed based on services usable in the sites, the capacities of the sites, the services used by the information processing systems, the restoration priorities of the information processing systems, and the like if a restoration destination of an information processing system does not exist. In addition, the stop process may be a so-called degradation process or a process of stopping a part of a resource of an information processing system or a process of reducing the performance of an information processing system.

As illustrated in FIG. 7, the capacity of the site A1 is 0, and the capacities of the sites B2 and C3 are 2. Specifically, an available resource in which an information processing system is able to be restored does not exist in the site A1, while available resources in which the information processing systems are able to be restored exist in the sites B2 and C3. In addition, the services A and B are usable in the site B2, while only the service B is usable in the site C3. Furthermore, as illustrated in FIG. 6, the information processing systems A4 and B5 use the service A, and the information processing systems C6, D7, and E8 use the service B.

According to the site management table 50 and the information processing system management table 60, the information processing system A4 is able to be restored in the site B2 or the site C3. The information processing system A4 uses the service A. Thus, if the information processing system A4 is restored in the site B2, the information processing system A4 is able to use the service A. If the information processing system A4 is restored in the site C3, the information processing system A4 is not able to use the service A. Thus, the CPU 101 determines that a restoration destination candidate of the information processing system A4 is the site B2. Similarly, the CPU 101 determines that a restoration destination candidate of the information processing system B5 is the site B2, and the CPU 101 determines that restoration destination candidates of the information processing systems C6 to E8 are the site B2 or the site C3. Then, the CPU 101 causes, based on the results of the determination, the restoration destination candidates of the information processing systems to be stored in the “restoration destination candidates” item 83 of the restoration process table 80, as illustrated in FIG. 8. When the CPU 101 determines the restoration destination candidates of the information processing systems, the CPU 101 causes the process to proceed to OP104.

In OP104, the CPU 101 determines restoration destinations of the information processing systems in order from an information processing system with the highest restoration priority. Specifically, the CPU 101 determines the restoration destinations of the information processing systems based on restoration destination candidates of the information processing systems within the restoration process table 80 created in OP103, the restoration priorities within the information processing system management table 60, and the capacities of the sites within the site management table 50.

FIG. 4 illustrates an example of a detailed subroutine process to be executed in OP104. In OP201, the CPU 101 determines whether or not an information processing system of which a restoration destination has yet to be determined exists among the information processing systems installed in the sites. For example, the CPU 101 sets, to ON, flags indicating whether or not a process of determining a restoration destination has been executed on the information processing systems in OP202 described below. The CPU 101 references the flags in OP201, thereby determining whether or not an information processing system that has yet to be subjected to the process of determining a restoration destination exists. If the information processing system that has yet to be subjected to the process of determining a restoration destination exists (Yes in OP201), the CPU 101 causes the process to proceed to OP202. If the information processing system that has yet to be subjected to the process of determining a restoration destination does not exist (No in OP201), the CPU 101 terminates the subroutine process and causes the process to proceed to OP105. In OP202, the CPU 101 functions as a determiner and determines a restoration destination of the information processing system that has yet to be subjected to the process of determining a restoration destination.

A specific example of processes of OP201 and OP202 is described below. If the information processing system management table 60 illustrated in FIG. 6, the site management table 50 illustrated in FIG. 7, and the restoration process table 80 illustrated in FIG. 8 are used and the restoration priorities are sorted in order from the highest priority as indicated by values indicated in the “restoration priority” item 63 of the information processing system management table 60, the information processing systems A4, B5, C6, D7, and E8 are sorted in this order. Thus, in OP202, the CPU 101 determines the restoration destination of the information processing system A4 while prioritizing the information processing system A4 over the other information processing systems. As indicated in the “restoration destination candidates” item 83 of the restoration process table 80, a restoration destination candidate of the information processing system A4 is the site B2. As indicated in the “capacity” item 53 of the site management table 50, the capacity of the site B2 is 2. Thus, the CPU 101 determines that the restoration destination of the information processing system A4 is the site B2.

In the aforementioned manner, the restoration destinations of the information processing systems are determined based on the restoration priorities of the information processing systems in the embodiment. Thus, even if the amount of resources in which information processing systems are able to be installed in each of the sites is reduced upon the occurrence of a disaster, resources may be assigned to the information processing systems in order from the information processing system with the highest restoration priority.

In the embodiment, the restoration destinations of the information processing systems are determined so that resource amounts assigned to the information processing systems installed in the sites do not exceed the capacities. Thus, when the restoration destinations of the information processing systems are determined so that the information processing systems are able to use the services in the restoration destinations, it may be possible to suppress insufficiency of the capacities of the sites and a state in which an information processing system is not able to be installed. The CPU 101 sets, to ON, a flag indicating whether or not the process of determining a restoration destination has been executed on the information processing system A4, and the CPU 101 causes the process to return to OP201.

The process of determining a restoration destination has yet to be executed on the information processing systems B5 to E8. Thus, the CPU 101 causes the process to proceed from OP201 to OP202. Then, in OP202, the CPU 101 determines that the restoration destination of the information processing system B5 is the site B2 in the same manner as the information processing system A4. In addition, the CPU 101 sets, to ON, a flag indicating whether or not the process of determining a restoration destination has been executed on the information processing system B5, and the CPU 101 causes the process to return to OP201.

The process of determining a restoration destination has yet to be executed on the information processing systems C6 to E8. Thus, the CPU 101 causes the process to proceed from OP201 to OP202. Then, in OP202, the CPU 101 determines the restoration destination of the information processing system C6. As indicated in the “restoration destination candidates” item 83 of the restoration process table 80, the restoration destination candidates of the information processing system C6 are the sites B2 and C3. Specifically, the information processing system C6 may be restored in the site B2 or the site C3. The capacity of the site B2 is 2, and the restoration destinations of the information processing systems A4 and B5 have already been determined to be the site B2. Thus, an available resource in which the information processing system C6 is able to be restored does not exist in the site B2. Thus, the CPU 101 determines that the restoration destination of the information processing system C6 is the site C3. The CPU 101 sets, to ON, a flag indicating whether or not the process of determining a restoration destination has been executed on the information processing system C6, and the CPU 101 causes the process to return to OP201.

The process of determining a restoration destination has yet to be executed on the information processing systems D7 and E8. Thus, the CPU 101 causes the process to proceed from OP201 to OP202. Then, in OP202, the CPU 101 determines that the restoration destination of the information processing system D7 is the site C3 in the same manner as the information processing system C6. In addition, the CPU 101 sets, to ON, a flag indicating whether or not the process of determining a restoration destination has been executed on the information processing system D7, and the CPU 101 causes the process to return to OP201.

The process of determining a restoration destination has yet to be executed on the information processing system E8. Thus, the CPU 101 causes the process to proceed from OP201 to OP202. Then, in OP202, the CPU 101 determines the restoration destination of the information processing system E8. In this case, the restoration destination candidates of the information processing system E8 are the sites B2 and C3. An available resource in which the information processing system E8 is able to be restored does not exist in the site B2, like the case of the information processing systems C6 and D7. In addition, the capacity of the site C3 is 2, and the restoration destinations of the information processing systems C6 and D7 have already been determined to be the site C3. Thus, an available resource in which the information processing system E8 is able to be restored does not exist in the site C3. Thus, since the information processing system E8 is not able to be restored in any of the sites A1, B2, and C3, the CPU 101 determines that the restoration destination of the information processing system E8 does not exist.

Then, the CPU 101 sets, to ON, a flag indicating whether or not the process of determining a restoration destination has been executed on the information processing system E8, and the CPU 101 causes the process to return to OP201. In this case, an information processing system that has yet to be subjected to the process of determining a restoration destination does not exist. Thus, the CPU 101 terminates the subroutine process and causes the process to proceed to OP105.

By executing the process of OP202, the information processing systems may use the services in the restoration destinations. Specifically, the restoration destinations of the information processing systems may be determined so that each of the information processing systems is not restored in a site in which the information processing system is not able to use a service.

In OP105, the CPU 101 determines details of the restoration process to be executed on the information processing systems A4 to E8 of which the restoration destinations have been determined in OP104 and causes the determined details of the restoration process to be stored in the “restoration process” item 84 of the restoration process table 80. If the restoration process table 80 illustrated in FIG. 8 is used, a failure has occurred in the information processing systems A4 and B5, and the restoration destinations of the information processing systems A4 and B5 have been determined to be the site B. Thus, the CPU 101 determines that details of the restoration process to be executed on the information processing systems A4 and B5 are “restoration”. In addition, a failure has not occurred in the information processing system C6, and the information processing system C6 is to be restored in the site C3 different from the site B2 in which the information processing system C6 is currently installed. Thus, the CPU 101 determines that a detail of the restoration process to be executed on the information processing system C6 is “movement”.

In the embodiment, if an information processing system (information processing system C6 in the aforementioned example) with a lower restoration priority is installed in the site B2, an information processing system (information processing systems A4 and B5 in the aforementioned example) with a higher restoration priority is not restored in the site B2. Thus, the restoration destinations are determined so that the information processing system with the lower restoration priority is to be moved from the site (site B2 in the aforementioned example) in which the information processing system with the lower restoration priority is currently installed to a site (site C3 in the aforementioned example) in which a function used by the information processing system with the lower restoration priority is usable. Thus, the restoration destinations of the information processing systems are determined so that the information processing system with the higher restoration priority is able to use a service in a restoration destination and that the information processing system with the lower restoration priority is able to use a service in the restoration destination.

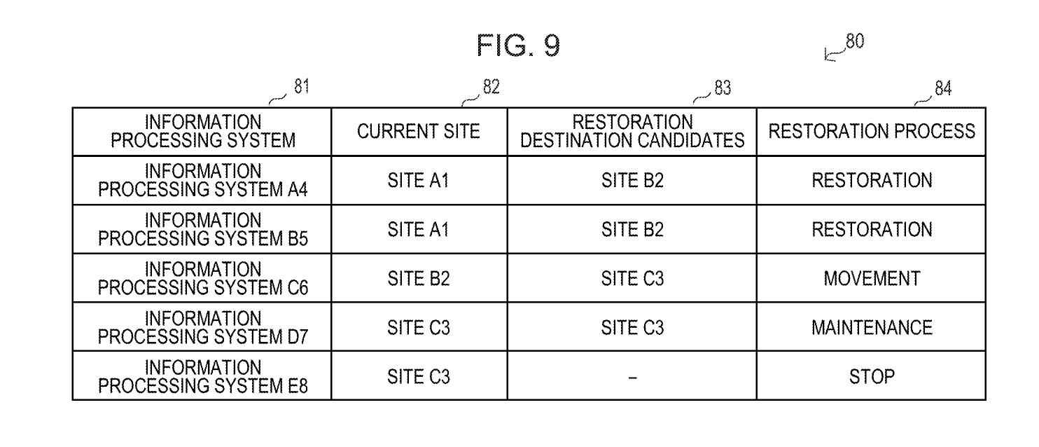

In addition, a failure has not occurred in the information processing system D7, and the information processing system D7 is continuously installed in the site C3 in which the information processing system D7 is currently installed. Thus, the CPU 101 determines that a detail of the restoration process to be executed on the information processing system D7 is “maintenance”. In addition, the restoration destination of the information processing system E8 does not exist. Thus, the CPU 101 determines that a detail of the restoration process to be executed on the information processing system E8 is “stop”. FIG. 9 illustrates an example of the restoration process table 80 after the details of the restoration process to be executed on the information processing systems are determined by the CPU 101 in OP105.

When the CPU 101 determines the details of the restoration process to be executed on the information processing systems and causes the determined details of the restoration process to be stored in the “restoration process” item 84 of the restoration process table 80, the CPU 101 transmits the restoration process table 80 to the other managing servers 11 and 12 via the management network 15. By executing this, the restoration process table 80 is shared by the managing servers 10 to 12. Then, the CPU 101 causes the process to proceed to OP106. In the following OP106 and OP107, the CPUs of the managing servers 10 to 12 mainly execute processes. The information processing systems installed in the sites are restored in the determined sites by the communication between the managing servers 10 to 12 via the management network 15.

In OP106, the CPUs of the managing servers 10 to 12 execute the restoration process on the information processing systems A4 to E8 based on the restoration process table 80 and the information processing system management table 60. Specifically, first, the CPUs of the managing servers 10 to 12 execute the stop process on an information processing system for which a detail of the restoration process has been set to “stop” in the restoration process table 80. Next, the CPUs of the managing servers 10 to 12 execute a process of moving an information processing system for which a detail of the restoration process has been set to “movement” in the restoration process table 80. Next, the CPUs of the managing servers 10 to 12 execute the process of restoring information processing systems for which details of the restoration process have been set to “restoration” in the restoration process table 80.

As an example, the case where the restoration process table 80 illustrated in FIG. 9 and the information processing system management table 60 illustrated in FIG. 6 are used is described below. In the restoration process table 80, the information processing system for which the detail of the restoration process has been set to “stop” is the information processing system E8. Thus, the CPU of the managing server 12 of the site C3 in which the information processing system E8 is installed executes the stop process on the information processing system E8. As a result, a resource in which the information processing system E8 has been previously installed is made available.

The information processing system for which the detail of the restoration process has been set to “movement” is the information processing system C6, and a destination to which the information processing system C6 is moved is the site C3, as indicated in the “restoration destination candidates” item 83 of the restoration process table 80. Thus, the CPU of the managing server 11 of the site B2 in which the information processing system C6 is installed makes available a resource in which the information processing system C6 has been previously installed. In the embodiment, the managing servers 10 to 12 share information of the information processing systems. Thus, the CPU of the managing server 12 of the site C3 installs the information processing system C6 in the resource made available by executing the stop process on the information processing system E8. As a result, the information processing system C6 previously installed in the site B2 is moved to the site C3.

The information processing systems for which the details of the restoration process have been set to “restoration” are the information processing systems A4 and B5. In addition, the restoration destinations of the information processing systems A4 and B5 are the site B2. The CPUs of the managing servers 10 to 12 execute the process of restoring the information processing systems in order from the information processing system with the higher restoration priority stored in the information processing system management table 60. Thus, first, the CPU of the managing server 11 of the site B2 installs the information processing system A4 in an available resource. Next, the CPU of the managing server 11 of the site B2 installs the information processing system B5 in an available resource. As a result, the information processing systems A4 and B5 that are using the service A are restored in the site B2 in which the service A is usable, and are not restored in the site C3 in which the service A is not usable.

When the process of restoring the information processing systems is completed in OP106, the CPUs of the managing servers 10 to 12 cause the process to proceed to OP107. In OP107, the CPUs of the managing servers 10 to 12 display, on monitors (the managing server 10 displays the results on the monitor 20), the results of executing the restoration process on the aforementioned information processing systems. The results of the restoration process include the details of the restoration process executed on the information processing systems, the sites in which the information processing systems are installed by the restoration process, and information indicating whether the restoration process has been successfully executed or has failed. Users of the managing servers 10 to 12 may confirm, based on the results of the restoration process that are displayed on the monitors, that the information processing systems have been restored in the sites in which the information processing systems are able to continuously use the services.

Although the embodiment is described above, the configurations and processes of the aforementioned servers and the like are not limited to those described in the embodiment and may be variously changed within a scope in which the changes remain identical to the technical idea of the present disclosure. For example, although the embodiment assumes the case where the sites use the services of the public clouds, information on usable hardware and software functions specific to the sites may be shared by the managing servers, like the aforementioned tables. Thus, the restoration destinations of the information processing systems may be determined so that the functions used by the information processing systems are usable in the restoration destinations.

In the embodiment, if a detail of the restoration process to be executed on an information processing system is “stop”, an entire resource of the information processing system is made available. Degradation of stopping a certain resource, however, may be applied as a detail of the restoration process instead of the stop process, for example. In this case, the certain resource stopped by the degradation may be used as a resource in which an information processing system is to be restored.

In the embodiment, a part of the aforementioned processes may be executed by a processor other than the CPUs, for example, by a dedicated processor such as a digital signal processor (DSP), a graphics processing unit (GPU), a numerical processor, a vector processor, or an image processing processor. In addition, a part of the aforementioned units may be an integrated circuit (IC) or another digital circuit. Furthermore, an analog circuit may be included in a part of the aforementioned units. Examples of the integrated circuit include a large-scale integration (LSI), an application specific integrated circuit (ASIC), and a programmable logic device (PLD). Examples of the PLD include a field-programmable gate array (FPGA). The aforementioned units may be a combination of the processor and the integrated circuit. The combination is referred to as microcontroller (MCU), system-on-a-chip (SoC), system LSI, chipset, or the like, for example.

Computer-Readable Recording Medium

A program for achieving a management tool for setting the aforementioned servers in a computer, another machine, or another device (hereinafter referred to as computer or the like), an operating system (OS), and a like may be stored in a computer-readable recording medium that is readable by the computer or the like. The program stored in the recording medium is read into the computer or the like and executed by the computer or the like, thereby providing the functions.

The computer-readable recording medium electrically, magnetically, optically, mechanically, or chemically accumulates information such as data, programs, and the like and is readable by the computer or the like. The recording medium may be detachable from the computer or the like. The detachable recording medium is, for example, a flexible disk, a magneto-optical disc, a CD-ROM, a CD-R, a CD-W, a DVD, a Blu-ray disc, a DAT, an 8 mm tape, a memory card such as a flash memory, or the like. The recording medium may be fixed to the computer or the like. The recording medium fixed to the computer or the like is a hard disk, a ROM, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device, comprising:
a memory; and
a processor coupled to the memory and the processor configured to:
acquire first information indicating functions used by respective information processing systems;
acquire second information indicating functions that are usable by the information processing systems in respective sites; and
when a failure has occurred in a first information processing system of the information processing systems installed in a first site of the sites, determine a second site in which a first function used by the first information processing system is usable based on the acquired first information and the acquired second information, the second site being one of the sites and different from the first site, the second site serving as a first restoration destination in which the first information processing system is restored.

2. The information processing device according to claim 1,
wherein the processor is further configured to:
identify, as the first function, a function indicated by the first information as to be used in the first information processing system; and
identify, as the first site, a site in which the first function is included in the usable functions indicated by the second information.

3. The information processing device according to claim 1,
wherein the processor is further configured to:
acquire third information indicating permissible values corresponding to the respective sites, the permissible values being predetermined for totals of resource amounts for information processing systems able to be installed in the respective sites; and
determine the first restoration destination such that a total of resource amounts assigned to information processing systems installed in the first restoration destination does not exceed a first permissible value corresponding to the first restoration destination, the first permissible value being indicated by the acquired third information.

4. The information processing device according to claim 1,
wherein the processor is further configured to:
acquire fourth information indicating restoration priorities of the respective information processing systems; and
determine, based on the acquired fourth information, the first restoration destination in order from an information processing system with a highest restoration priority.

5. The information processing device according to claim 4,
wherein the processor is further configured to:
when a second information processing system of the information processing systems is installed in the first restoration destination, determine that the second information processing system is to be moved from the restoration destination to a site in which a function used by the second information processing system is usable, the second information processing system having a restoration priority lower than a restoration priority of the first information processing system.

6. A method of controlling an information processing device, the method comprising:
determining, by a processor included in the information processing device, whether a failure has occurred in at least one of a plurality of information processing systems;
when a determination is made that the failure has occurred:
acquiring a site management table and an information processing system management table;
determining restoration destination candidates;
creating a restoration process table using the restoration destination candidates;
determining a restoration destination based on the restoration process table;
determining a restoration process using the restoration destination;
executing the restoration process; and
displaying a restoration result.

7. The method of claim 6, wherein the determining whether the failure has occurred includes monitoring failure occurrence states of the plurality of information processing systems.

8. The method of claim 6 further comprising notifying the plurality of information processing systems of the failure.

9. The method of claim 8, wherein the notifying includes updating the site management table.

10. The method of claim 6, wherein the restoration process includes any one of a restoration, movement, maintenance or stop process.

11. A non-transitory computer-readable recording medium having stored therein a program that causes a computer to execute a process, the process comprising:
acquiring first information indicating functions used by respective information processing systems;
acquiring second information indicating functions that are usable by the information processing systems in respective sites; and
when a failure has occurred in a first information processing system of the information processing systems installed in a first site of the sites, determine a second site in which a first function used by the first information processing system is usable based on the acquired first information and the acquired second information, the second site being one of the sites and different from the first site, the second site serving as a first restoration destination in which the first information processing system is restored.

12. The non-transitory computer-readable recording medium according to claim 11, the process further comprising:
identifying, as the first function, a function indicated by the first information as to be used in the first information processing system; and
identifying, as the first site, a site in which the first function is included in the usable functions indicated by the second information.

13. The non-transitory computer-readable recording medium according to claim 11, the process further comprising:
acquiring third information indicating permissible values corresponding to the respective sites, the permissible values being predetermined for totals of resource amounts for information processing systems able to be installed in the respective sites; and
determining the first restoration destination such that a total of resource amounts assigned to information processing systems installed in the first restoration destination does not exceed a first permissible value corresponding to the first restoration destination, the first permissible value being indicated by the acquired third information.

14. The non-transitory computer-readable recording medium according to claim 11, the process further comprising:
acquiring fourth information indicating restoration priorities of the respective information processing systems; and
determining, based on the acquired fourth information, the first restoration destination in order from an information processing system with a highest restoration priority.

15. The non-transitory computer-readable recording medium according to claim 14, the process further comprising:
when a second information processing system of the information processing systems is installed in the first restoration destination, determining that the second information processing system is to be moved from the restoration destination to a site in which a function used by the second information processing system is usable, the second information processing system having a restoration priority lower than a restoration priority of the first information processing system.
